(19) United States
(12) Patent Application Publication
(10) Pub. No.: US 2016/0110641 A1
(43) Pub. Date: Apr. 21, 2016

(54) DETERMINING A LEVEL OF RISK FOR MAKING A CHANGE USING A NEURO FUZZY EXPERT SYSTEM

(71) Applicant: HEWLETT-PACKARD DEVELOPMENT COMPANY, L.P., Houston, TX (US)

(72) Inventor: Plamen Valentinov Ivanov, Sofia (BG)

(73) Assignee: HEWLETT-PACKARD DEVELOPMENT COMPANY, L.P., Houston, TX (US)

(21) Appl. No.: 14/888,131

(22) PCT Filed: Jul. 31, 2013
(86) PCT No.: PCT/US2013/052887

§ 371 Date: Oct. 30, 2015

(51) Int. Cl. G06N 3/04; G06N 3/08

(52) U.S. Cl. CPC G06N 3/0436; G06N 3/08

(57) ABSTRACT

Determining a level of risk for making a change is provided. Valid-trained-neuro-fuzzy-expert-system-logic is generated. A plurality of input values is received. The input values are analyzed using the valid-trained-neuro-fuzzy-expert-system-logic. A level of risk of making the change is determined based on the analyzing of the input values.

### RELATED APPLICATIONS

This application is related to co-pending U.S. Patent Application No. PCT/US2012/047501, filed on Jul. 20, 2012, entitled “PROBLEM ANALYSIS AND PRIORITY DETERMINATION BASED ON FUZZY EXPERT SYSTEMS,” by Ivanov, having Attorney Docket No. 83014356 and assigned to the assignee of the present application.

### BACKGROUND

Frequently, organizations need to make changes to their information technology (IT) infrastructure. Generally, changes involve risk. Although a simple change may seem innocuous, the simple change to the IT infrastructure can still cause a large amount of damage in proportion to their complexity. There are a many examples of expensive impacts caused, for example, by one missing symbol in software code.

### BRIEF DESCRIPTION OF THE DRAWINGS

The accompanying drawings, which are incorporated in and form a part of this Description of Examples, illustrate various examples of the present disclosure and, together with the description, serve to explain principles discussed below: The Figures are not drawn to scale unless specified.

FIG. 1 depicts hierarchical neural network, according to one embodiment.

FIG. 2 depicts a change risk determination system, according to one embodiment.

FIG. 3 depicts a flow chart of a method of determining a level of risk for making a change, according to one embodiment.

FIG. 4 depicts a change risk determination system, according to one embodiment.

FIG. 5 depicts a hierarchical neural network, according to one embodiment.

FIG. 6 depicts a flowchart 600 for generating a valid trained neural network, according to one embodiment.

### DETAILED DESCRIPTION EXAMPLE

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in the following Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Unless specifically stated otherwise as apparent from the following discussions, it is appreciated that throughout the description of embodiments, discussions utilizing terms such as “generating,” “receiving,” “analyzing,” “determining,” “communicating,” “training,” “performing,” “processing,” “detecting,” “operating,” “using,” “accessing,” “transitioning,” “comparing,” “associating,” “requesting,” “deleting,” “modifying,” “adding,” “receiving,” “transmitting,” “communicating,” “creating,” “obtaining,” “executing,” “storing,” “detecting,” “switching,” “causing,” “transforming data,” “modifying data to transform the state of a computer system,” or the like, refer to the actions and processes of a computer system, data storage system, storage system controller, microcontroller, processor, such as a central processing unit (CPU), or similar electronic computing device or combination of such electronic computing devices. The computer system or similar electronic computing device manipulates and transforms data represented as physical (electronic) quantities within the computer system's/device's registers and memories into other data similarly represented as physical quantities within the computer system's/device's memories or registers or other such information storage, transmission, or display devices.

Many organizations use a simple matrix to categorize risk and to determine the level of risk for a change (also referred to as “change risk”) to an IT infrastructure. However, these matrixes are static with predefined combinations of possible input values and output values based on their selection. The static matrix solution uses only two input values which are not enough for assessing real and objective change risk. Additionally, realistic solutions can be very complex and hard to implement especially when calculating more than three input variables.

Other organizations may use a Microsoft (MS) Excel file as a “Change Risk Impact Assessment Tool.” Such a file contains several assessment criteria for which a person must select linguistic input values. Based on the selected linguistic value a specific predefined digit value is set, for example, between the values of 1 and 10. For each of these assessment criteria a different weight is defined which is multiplied with the predefined digital value. The change risk is defined based on the summation of tine weighted input digital values and intervals of the predefined result values. This type of file provides a distributed solution which is very hard to keep up to date for all of the personal who are using it. Additionally the person who is calculating the risk using the file could manipulate the predefined values, weights and result. This can lead to an unrealistic and subjective assessment of the level of risk that results from a potential change.

Other organizations may use a change management workflow tool application which is a type of risk assessment calculator. A change management workflow tool application includes a questionnaire based on predefined questions which represent risk factors. Based on these risk factors, the level of risk that results from a potential change can be calculated. Weights are predefined and associated with each of the questions. The risk is calculated by the system based on the selected values, which are ordinarily selected from drop-down menu with predefined possible linguistic values, for each of the risk factors.

For all of these conventional solutions, the human problem creator defines the values of the input variables based on their own perception, understanding, instinct, intuition, knowledge, team discussions and so on. This can lead to subjective and unrealistic assessment of the risk involved in making a change. The result will frequently be an incorrectly implemented change which can lead to occurrences of incidents and problems some with critical impact on the business operations and processes. Additionally, the possibilities of breaching the service level agreements (SLAs) will increase.

Additionally the available previous solutions do not provide learning and training functionality, which can eliminated or reduce the dependency of constantly keeping experts available.

Generally, changes involve risk. Although a simple change may seem innocuous, the simple change can still cause a large amount of damage in proportion to their complexity. There are a many examples of high business impact and expensive business impact caused, for example, by one missing symbol in software code. Therefore, according to one embodiment, factors are identified that may disrupt the business, impede the delivery of service warranties or impact corporate objectives and policies. The issue of risk to the business of any change is considered prior to the authorization of any change, according to one embodiment.

According to one embodiment, the risk is understood and evaluated from the business perspective, for example, by a service provider. Assessing risk from the business perspective can produce the correct or best possible course of action which can be very different from that chosen from an information technology (IT) perspective. Therefore, according to one embodiment, various impact criteria from business perspective are considered during change risk analysis and assessment. For example, as many as possible impact criteria are considered. Possible criteria used for more realistic and accurate change risk analysis can include:
Impacted Business Services and Processes
Affected Configuration Items (Servers, Applications, Software, Network components and etc)
Necessary people resources for change implementation
Related for implementation changes
Organizational visibility
Back out (rolled back) efforts
Resources experience
Expected time for change completion
Change implementation time
Estimated financial impact
People affected

Answers to these questions involve experience, broad and deeper knowledge, and skills of experts in several domains. Most of the personnel who are planning the change and analyzing its risk are not experts or do not possess all the necessary skills or knowledge to perform detailed and objective analysis.

To perform such activity, according to one embodiment, an intelligent technique is used in order to quantify more realistically the change risk analysis and derive a level of change risk. According to one embodiment, the intelligent technique has learning capabilities in order to follow the organization internal changes and reduce the dependence on human experts.

Change Management is one of the information technology infrastructure library (ITIL) processes that are a suitable candidate for implementing intelligent techniques like fuzzy logic for its optimization. The change management process controls and manages changes to services and associated IT infrastructure components, which are represented as Configuration Items (CIs), promotes business benefits while minimizing the risk of disruption to services and therefore the impact on the business. Change Management manages coordinates and controls the implementation of Requests for Change (RFCs).

One of the crucial moments during change planning phase is the change risk assessment phase. Risk can be identified as the harm or loss that results from a possible event or the affect on the ability to achieve defined objectives. A risk can be measured by the probability of a threat, the vulnerability of the asset to that threat, or the impact an event would have if it occurred, or a combination thereof. Risk assessment can involve analyzing threats and weaknesses that have been or would be introduced as a result of a service change.

Therefore, according to various embodiment, a change risk determination system is provided that includes neuro-fuzzy expert system logic that is used as a part of analyzing changes to the IT infrastructure and the risk that results from those changes. According to one embodiment, the change risk determination system combines an intelligent technique like fuzzy logic, neural networks, ITIL framework recommendations and practice techniques. According to one embodiment, the change risk determination system can execute the process of change risk analysis and assessment in the IT service management area using the neuro-fuzzy expert system logic. The change risk determination system can deal with the ambiguity of representations of human expert knowledge by using fuzzy logic. Ambiguity can be defined as a condition where there is limited knowledge or it is not possible to precisely define the current state or future result.

According to one embodiment, the change risk determination system can deliver a new approach for better and more intelligent use of the human expert knowledge for change risk analysis and uses fuzzy logic to quantify more realistically the classical change risk analysis and to arrive at conclusion that represents the risk of making a change. Additionally the change risk determination system can implement the neural networks learning capabilities. A neural network with learning capabilities combined with fuzzy logic represents neuro-fuzzy-expert-system-logic, which can deliver the best of both.

The change risk determination system can be implemented on a single server, distributed across a plurality of serves, or as cloud based solution. The cloud based solution can optimize the management of resources, costs, storage and performance based on the corporate or regulatory policies or a combination thereof.

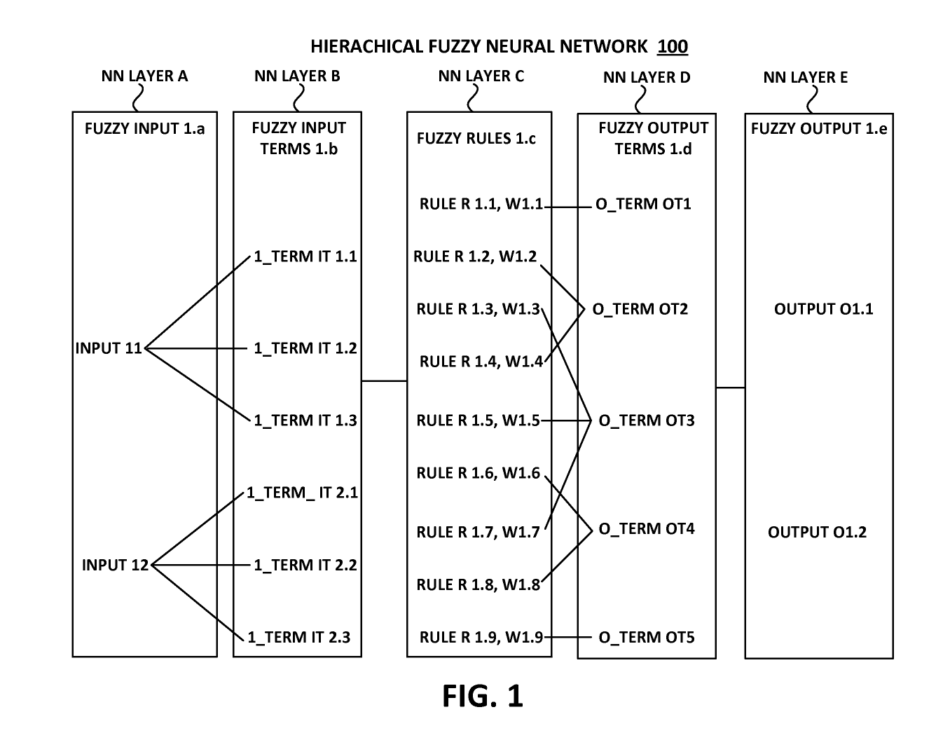

FIG. 1 depicts hierarchical neural network, according to one embodiment.

As depicted in FIG. 1, the neural network is hierarchical with five neural network layers. The first neural network layer A is the fuzzy input value nodes 1.a, the second neural network layer B is the fuzzy input value term nodes 1.b, the third neural network layer C is the fuzzy rule nodes 1.c, the fourth neural network layer D is the fuzzy output value term nodes 1.d, and the fifth layer E is the fuzzy output value nodes 1.e.

More specifically, the five neural network layers include:
A. Neural network layer A (FIG. 1) includes two inputs I1 and I2 (FIG. 1). According to one embodiment, both of these inputs I1 and I2 are crisp input value nodes and can contain values as discussed herein.
B. Neural network layer B (FIG. 1), which contains the input fuzzy value terms 1.b (FIG. 1). The fuzzy input terms 1b (FIG. 1) are associated with the fuzzy inputs 1a (FIG. 1), for example, as discussed herein. The fuzzy input terms 1b can have values such as “few,” “average,” “many,” low,” “medium,” “high,” as discussed herein.
C. Neural network layer C (FIG. 1), which contains the fuzzy rules 1.c, as discussed herein. The fuzzy rules 1.c, according to one embodiment, are fuzzy rule nodes.
D. Neural network layer D, which contains the fuzzy output terms OT1-OT5. The fuzz output terms OT1-OT5 are fuzzy output term nodes, according to one embodiment. According to one embodiment, the fuzzy output terms OT1-OT5 represent terms such as “No Risk”, “Low Risk”, “Medium Risk”, “High Risk” and “Very High Risk”.
E. Neural network layer E contains the fuzzy output o1.1 and the fuzzy output o1.2. According to one embodiment, the fuzzy output o1.1 is a linguistic value, such as “no risk,” and the fuzz output value o1.2 is a defuzzified real number value that corresponds with the fuzz output o1.1.

For the sake of simplicity, the hierarchical neural network depicts input values 1.a that includes two inputs I1 and I2. However, various embodiments are well suited to more inputs. For example, various embodiments are well suited to eleven inputs, as will become more evident. However, the inputs may be more or less than eleven. The input values 1.a may be entered by a human or received automatically from another system that communicates with the change risk determination system or a combination thereof. Inputs 1a and outputs 1e are variables that have names and values. Examples of eleven inputs 1a and their corresponding variable names, depicted to the left of the colons, and possible fuzzy values, depicted to the right of the colons and inside of the brackets, are as follows:
Impacted Business Services and Processes: {none, few, average, many, too many};
Affected Configuration Items (Servers, Applications, Software, Network components and etc): {none, few, average, many, too many}
Necessary people resources for change implementation: {small sized team, middle sized team, large sized team}
Related changes: {none, several, not too many, many, too many}
Organizational visibility: {low, medium, high}
Back out efforts (Rolled back efforts): {none, minimal (easily executed), some (possible but not so easily executed), large (difficult or impossible)}
Number of resources with necessary experience: {few, average, many}
Expected time for change completion: {low risk, low to medium risk, average risk, high risk, highest risk (too much risk)}
Change implementation time: {working time, non-working time, holiday}
Estimated financial impact: {low (<10 000 $ for example), medium (between 10 000 and 50 000 $ for example), high (between 50 000 and 100 000 $ for example) and highest (over 100 000 $ for example)}
People affected: {none, few, average, many, too many}

Although 11 inputs 1.a have been described, various embodiments are well suited to fewer or more inputs.

For this illustration, assume that the input I1 could be for the number of resources with necessary experience and input I2 could be for organizational visibility.

Each of the inputs I1 and I2 are linked to a plurality of input terms IT1.1, IT1.2, IT1.3, IT2.1, IT2.2, and IT2.3 (also referred to as “i_terms”). For example, input I1 is linked with input terms IT1.1, IT1.2, IT1.3 and input I2 is linked with terms IT2.1, IT2.2, and IT2.3.

Each of the input terms 1.b are linked with one or more fuzzy rule nodes. Each of the input terms 1.b can be terms like: “few”, “average,” “many”. These are just a few examples of terms that input terms can have. The input terms 1.b can be any terms that describe various degrees of an input 1.a, such as but not limited to, none, few, average, many, too many, small sized team, middle sized team, large sized team, some, large, low risk, low to medium risk, average risk, high risk, highest risk (too much risk), working time, non-working time, holiday, low (<10 000 $ for example), medium (between 10 000 and 50 000 $ for example), high (between 50 000 and 100 000 $ for example) and highest (over 100 000 $ for example).

As depicted in FIG. 1, there are 9 fuzzy rules 1.c, which are fuzzy rules r1.1-r1.9. Further, as depicted in FIG. 1, the single linked between fuzzy input terms 1.b and fuzzy rules 1.c indicates that each of the input terms IT1.1, IT1.2, IT1.3, IT2.1, IT2.2, and IT2.3 are linked with each of the 9 rules r1.1-r1.9. The rules, according to one embodiment, can be specified in terms of logical operators, such as, but not limited to, if, then, and, or. More specifically, the rules can be specified in terms of more than one fuzzy input to determine a fuzzy output, for example. Examples of fuzzy rules are:
Rule r1.1: IF ‘INPUT I1’ IS “Few” AND ‘INPUT I2’ IS “Low” THEN ‘OUTPUT O1.1’ IS “No Risk”
Rule r1.2: IF ‘INPUT I1’ IS “Few” AND ‘INPUT I2’ IS “Medium” THEN ‘OUTPUT O1.1’ IS “Low Risk”
Rule r1.3: IF ‘INPUT I1’ IS “Few” AND ‘INPUT I2’ IS “High” THEN ‘OUTPUT O1.1’ IS “Medium Risk”
Rule r1.4: IF ‘INPUT I1’ IS “Fairly” AND ‘INPUT I2’ IS “Low” THEN ‘OUTPUT O1.1’ IS “Low Risk”
Rule r1.5: IF ‘INPUT I1’ IS “Fairly” AND ‘INPUT I2’ IS “Medium” THEN ‘OUTPUT O1.1’ IS “Medium Risk”
Rule r1.6: IF ‘INPUT I1’ IS “Fairly” AND ‘INPUT I2’ IS “High” THEN ‘OUTPUT O1.1’ IS “High Risk”
Rule r1.7: IF ‘INPUT I1’ IS “Many” AND ‘INPUT IK2’ IS “Low” THEN ‘OUTPUT O1.1’ IS “Medium Risk”
Rule r1.8: IF ‘INPUT I1’ IS “Many” AND ‘INPUT I2’ IS “Medium” THEN ‘OUTPUT O1.1’ IS “High Risk”
Rule r1.9: IF ‘INPUT I1’ IS “Many” AND ‘INPUT I2’ IS “High” THEN ‘OUTPUT O1.1’ IS “Very High Risk”

Each of these rules r1.1 to r1.9 can have a weight named as ‘wₓ’ (like w_{1.1}, w_{1.2} and so on to w_{1.9}) which represents the weight or strength of each rule in relation to the other rules in the system.

As depicted, there are 5 output terms OT1, OT2, OT3, OT4, and OT5 (also referred to as “o_terms”). Examples of the output terms OT1-OT5 are “no risk,” “low risk,” “medium risk,” “high risk,” and “very high risk.”

As depicted, rule r1.1 is linked with output term OT1, rule r1.2 is linked with output term OT2, rule r1.3 is linked with output term OT3, rule r1.2 is linked with output term OT2, rule r1.5 is linked with output term OT3, rule r1.6 is linked with output term OT4, rule r1.7 is linked with output term OT3, rule r1.8 is linked with output term OT4, and rule r1.9 is linked with output term OT5.

Each of the output terms 1.d can be linked with an output 1.e. As depicted in FIG. 1, the single link between the fuzzy output terms 1.d and the fuzzy outputs 1.e indicates that each of the output terms OT1-OT5 are linked with each of the outputs O1.1 and O1.2.

Outputs O1.1 and O1.2 represent respectively a linguistic output and a crisp output. According to one embodiment, there is one linguistic output and one crisp output for all of the output terms 1.d. According to one embodiment, the fuzzy output o1.1 is a linguistic value. Examples of a linguistic output are “no risk,” “low risk,” “medium risk,” “high risk,” and “very high risk,” and so on. The fuzz output value O1.2 is crisp value that is a defuzzified real number value that corresponds with the fuzz output O1.1.

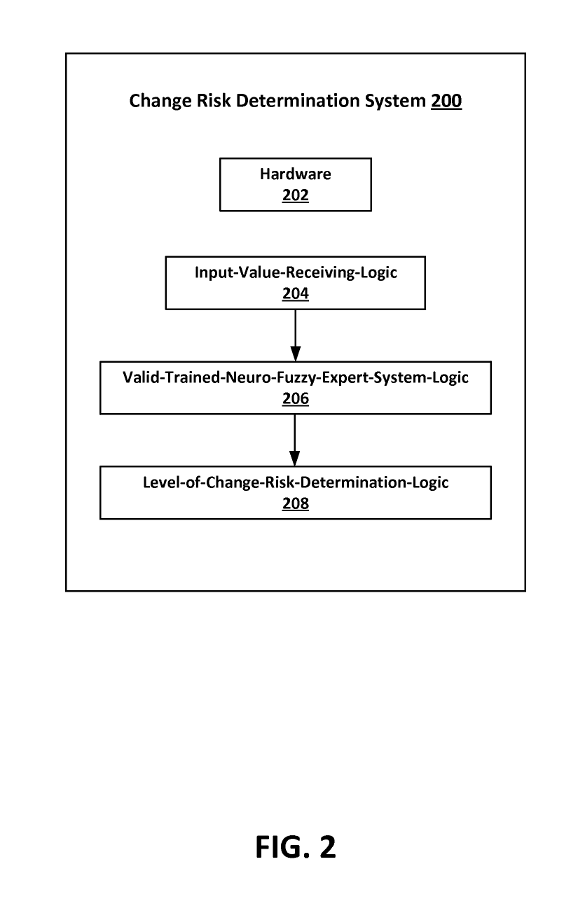

FIG. 2 depicts a change risk determination system 200, according to one embodiment. The blocks that represent features in FIG. 2 can be arranged differently than as illustrated, and can implement additional or fewer features than what are described herein. Further, the features represented by the blocks in FIG. 2 can be combined in various ways. The system 200 can be implemented using hardware, hardware and software, hardware and firmware, or a combination thereof.

The change risk determination system 200, according to one embodiment, includes hardware, an input-value-receiving-logic 204, a valid-trained-neuro-fuzzy-expert-system-logic 206, and a level-of-change-risk-determination-logic 208. Examples of the hardware could be a tangible computer readable storage medium for storing computer executable instructions or a hardware processor for executing instructions, such as a central processing unit, or a combination thereof. Examples of instructions are computer-executable instructions for implementing the input-value-receiving-logic 204, the valid-trained-neuro-fuzzy-expert-system-logic 206, and the level-of-change-risk-determination-logic 208. The logic may be implemented as computer-executable instructions, firmware or hardware, such as circuitry.

The input-value-receiving-logic 204 is configured for receiving a plurality of input values. The valid-trained-neuro-fuzzy-expert-system-logic 206 is configured for analyzing the input values using, for example, a neural network and fuzzy logic. The level-of-change-risk-determination-logic 208 is configured for determining a level of risk of making the change based on the analyzing of the input values.

According to one embodiment, the system 200 includes training-neural-network-logic that is configured for receiving training data and generating a trained neural network by training a neural network based on the training data, where the valid-trained-neuro-fuzzy-expert-system-logic 206 includes the trained neural network. The training-neural-network-logic can modify fuzzy input terms, fuzzy rules, or fuzzy output terms, or a combination thereof, based on the training data.

According to one embodiment, the system 200 includes validating-and-optimizing-trained-neural-network-logic that is configured for generating a valid neural network by validating and optimizing the trained neural network. According to one embodiment, the trained neural network is a hierarchical trained neural network with a plurality of layers.

According to one embodiment, the change risk determination system 200 form an architectural point can contain three layers, which include:
Application layer;
Communication layer;
Neuro-Fuzzy layer.

These three layers can be implemented on a single server, a plurality of servers or on the cloud. The cloud based solution can be used to optimize the management of resources, costs, storage and performance based on the corporate or regulatory policies. The “Neuro-fuzzy layer,” where the valid-trained-neuro-fuzzy-expert-system-logic 206 is located, can be in a public environment, a private environment or on a local environment. The ‘Communication layer’ can represent the Internet, Extranet or other local communication or shared environment. The ‘Application layer’ can be in a public environment, a private environment or on a local environment.

The application layer, according to one embodiment, represents the interaction point between a user and the change risk determination system 200 where the user can create, review and manage IT service management changes. For example, the application layer can enable a user to enter input values, fuzzy input terms, fuzzy rules, fuzzy output terms, among other things.

According to one embodiment, the change risk determination system 200 is developed using workflow based system and realizes the process of Change Management. A workflow system can provide powerful automatic mechanisms for managing the execution of business processes. The workflow approach helps to separate the business logic from the underlying information systems which allows the business processes to be designed without major changes on the underlying computing infrastructure. The communication layer represents the environment through which the application and neuro-fuzzy layers communicate with each other and exchange data including input values for change risk analysis and change risk result values (linguistic and numeric one).

The Neuro-Fuzzy layer includes a hierarchical valid-trained-neuro-fuzzy-expert-system-logic 206 which can perform analysis based on the gathered and structured expert knowledge in the form, for example, of fuzzy variables (including their membership functions), fuzzy rules, fuzzy inference engine, defuzzification method. Therefore, according to one embodiment, a neuro-fuzzy-expert-system-logic is a combination of a neural network and a fuzzy system. Further, the neural network of the neuro-fuzzy-expert-system-logic is hierarchical. The change risk determination system 200 can work with, for example, 11 input variables. Additionally, a fuzzy neural network can be trained with a sample of training data which can eliminate or minimize the need of constantly keeping experts available to gather and implement necessary expert knowledge, tune and optimize a trained fuzzy neural network. The valid trained fuzzy neural network can be used as or is a part of valid-trained-neuro-fuzzy-expert-system-logic 206.

According to one embodiment, change risk analysis fuzzy sets and fuzzy numbers are used to model the input words (like for example “low,” “medium,” or “high”) for change risk determination. Each of the inputs can be modeled with terms using triangular, sinusoidal or trapezoidal numbers. The input variables 1.a (FIG. 1) and their possible fuzzy values can be represented, according to various embodiments, as described herein.

For change risk analysis, fuzzy sets and fuzzy numbers can be used to model output words, such as “low,” “medium,” or “high,” representing the calculated level of risk of making a change. The words can be modeled with terms, for example, using triangular, sinusoidal or trapezoidal numbers. The output, which can represent a level of risk involved in making a change, and the output's possible fuzzy values can be represented, for example, as follows:
No Risk
Low Risk
Medium Risk
High Risk
Very High Risk

One of the components of the valid-trained-neuro-fuzzy-expert-system-logic 206 is a fuzzy neural network which is depicted in the FIG. 1.

In the operational mode of change risk determination system 200, a set of fuzzy rules ‘1.c ’ are applied to a set of fuzzy inputs I1 and I2′ and their respective input terms 1.b in order to generate fuzzy outputs o1.1 and o1.2, which are used for change risk determination.

Therefore, according to various embodiments, a change risk determination system is provided that includes neuro-fuzzy expert system logic that is used as a part of analyzing changes to the IT infrastructure and the risk that results from those changes. According to one embodiment, the change risk determination system 200 combines an intelligent technique like fuzzy logic, neural networks, ITIL framework recommendations and practice techniques. According to one embodiment, the change risk determination system can execute the process of change risk analysis and assessment in the IT service management area using the neuro-fuzzy expert system logic. The change risk determination system can deal with the ambiguity of representations of human expert knowledge by using fuzzy logic. Ambiguity can be defined as a condition where there is limited knowledge or it is not possible to precisely define the current state or future result.

According to one embodiment, the change risk determination system can deliver a new approach for better and more intelligent use of the human expert knowledge for change risk analysis and uses fuzzy logic to quantify more realistically the classical change risk analysis and to arrive at conclusion that represents the risk of making a change. Additionally the change risk determination system 200 can implement the neural networks learning capabilities. A neural network with learning capabilities combined with fuzzy logic represents neuro-fuzzy-expert-system-logic 206, which can deliver the best of both.

The change risk determination system 200 can be implemented on a single server, distributed across a plurality of serves, or as cloud based solution. The cloud based solution can optimize the management of resources, costs, storage and performance based on the corporate or regulatory policies or a combination thereof.

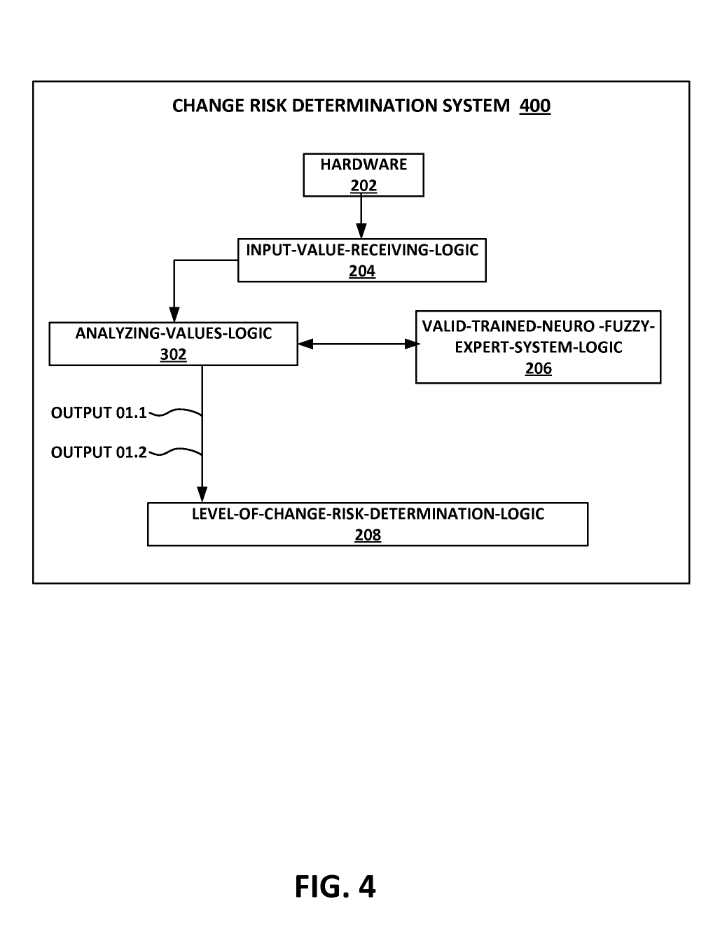

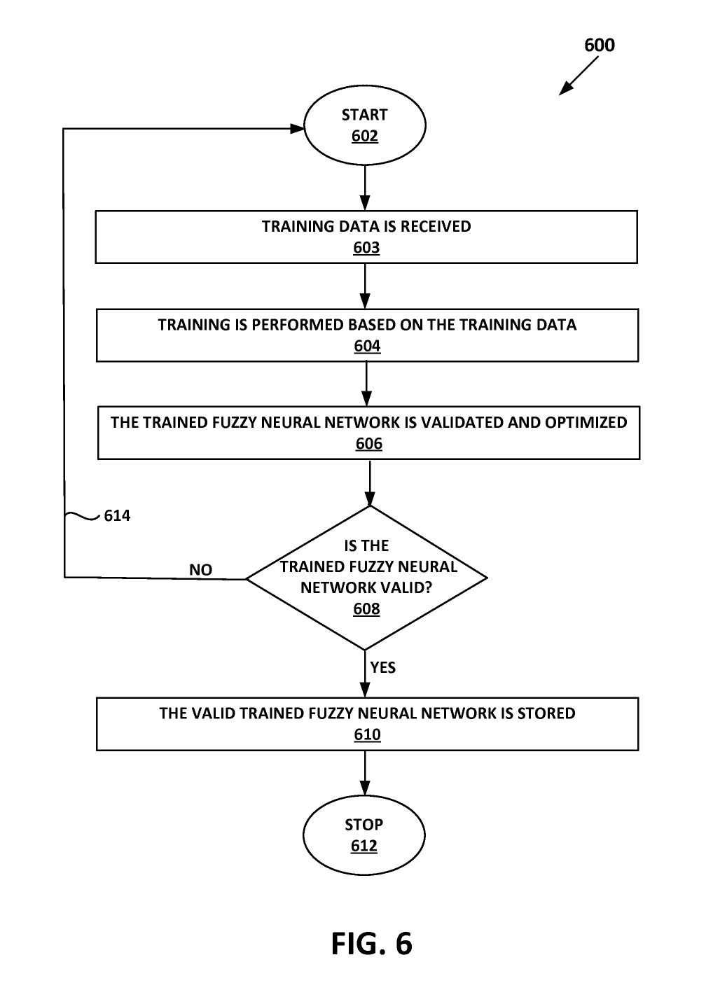

The change risk determination system 200 can operate in two modes:
Operational mode. In this mode, the system 200 analyzes the IT infrastructure change risk based on the transferred from the application architectural layer crisp values and the knowledge and configuration of the neuro-fuzzy expert system logic. The system 200 provides output that represents the linguistic value and crisp value of the calculated level of risk of change. These values can be transferred back to the application architectural layer for further processing and execution. The processing for the operational mode is described in detail in the context of FIG. 4 and with more details below.
Training mode. In this mode the system 200 is trained with the available neural network training data. This aspect of the system 200 allows for faster update of the neuro-fuzzy-expert-system-logic 206 based on the new or changed data, conditions, and policies. Additionally this eliminates or minimizes the need of a human expert who constantly updates the knowledge of the neuro-fuzzy-expert-system-logic 206. The processing for this mode is represented in FIG. 6 and with more details below.

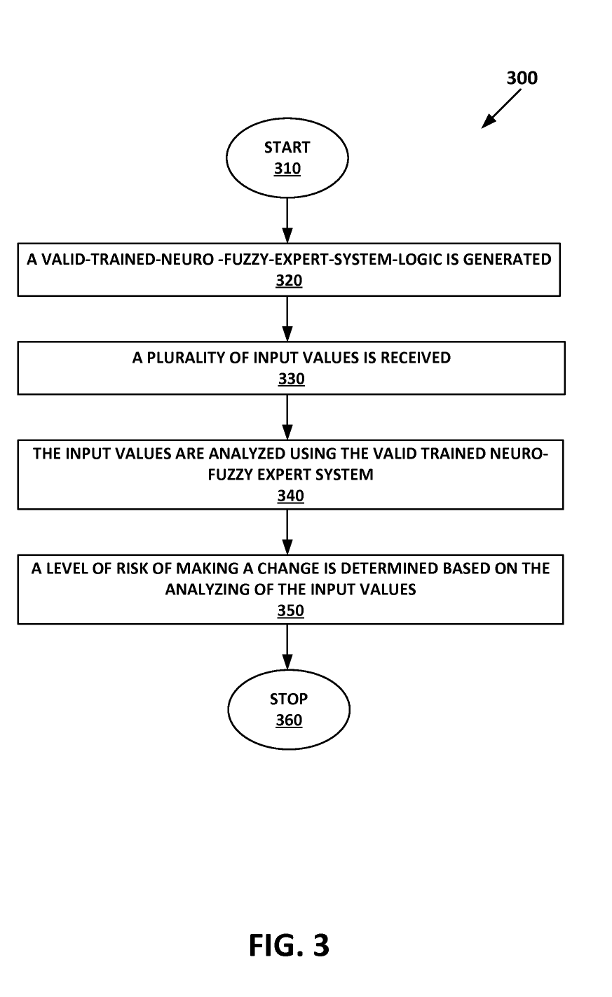

The operational mode follows the training mode after which the neuro-fuzzy-expert-system-logic 206 is trained and ready to operate. During the operational mode, the neuro-fuzzy-expert-system-logic 206 does not continue to learn, according to one embodiment. The operational mode of system 200's processing is described in more detail in the context of FIGS. 3 and 4.

FIG. 3 depicts a flow chart 300 of a method of determining a level of risk for making a change, according to one embodiment.

At 310, the method starts.

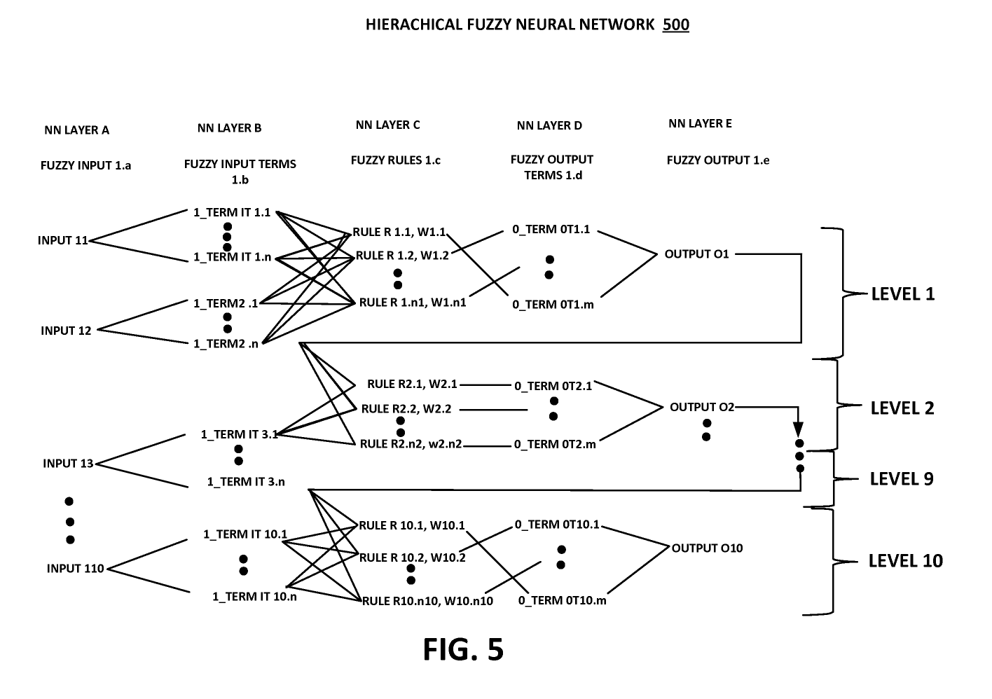

At 320, a valid-trained-neuro-fuzzy-expert-system-logic is generated. For example, a method of generating a valid-trained-neuro-fuzzy-expert-system-logic 206 (FIG. 2) is described in more detail in the context of FIG. 5.

At 330, a plurality of input values is received. For example, the input-value-receiving-logic (FIG. 2) can receive input values 1a (FIG. 1).

For change risk analysis, fuzzy sets and fuzzy numbers can be used to model input words, such as “low,” “medium,” or “high,” for change risk determination. Each of these words can be modeled with terms using, for example, triangular, sinusoidal or trapezoidal numbers. Examples of fuzzy input values 1a and their possible fuzzy values are as follows:

At 340, the input values are analyzed using the valid-trained-neuro-fuzzy-expert-system. For example, the analyzing of the input values 1a (FIG. 1) can be performed by a valid-trained-neuro-fuzzy-expert-system-logic 206 (FIG. 2). The valid-trained-neuro-fuzzy-expert-system-logic 206 (FIG. 2) can perform processing associated, for example, with layers B-E (FIG. 1). More specifically, the valid-trained-neuro-fuzzy-expert-system-logic 206 analyzes the fuzzy inputs 1.a based, for example, on the fuzzy input terms 1.b, fuzzy rules 1.c, fuzzy output terms 1.d to determine a fuzzy output 1.e (FIG. 1), according to one embodiment. However, the valid-trained-neuro-fuzzy-expert-system-logic 206 (FIG. 2) can perform processing with more or fewer layers.

The output 1.e can be specified as a linguistic value O1.1 or a crisp value O1.2 or a combination thereof. The linguistic value O1.1 and the crisp value O1.2 can be determined sequentially or in parallel.

At 350, a level of risk of making a change is determined based on the analyzing of the input values. For example, a level-of-change-risk-determination-logic 208 (FIG. 2) can determine the level of risk of making a change based on analyzing input values. More specifically, based on both output values, the linguistic value O1.1 and the crisp value O1.2, a level of risk of the change can be determined by a level-of-change-risk-determination-logic 208 (FIG. 2). For example, the changes can be classified by their risk level according to the linguistic value O1.1 and, subsequently, a level of risk of the change (also referred to as “grading”) can be determined using the crisp value O1.2. Hence, the linguistic value 5.e can be used to determine a class or category for each risk of change and the crisp value O1.2 can be used to index the risk of change in that class or category. Yet, the crisp value O1.2 can also be used to further affect the determined class or category, such that a risk of change can be reclassified into a neighboring class or category if the crisp value O1.2 exceeds or falls below a certain threshold.

At 360, the method ends.

FIG. 4 depicts a change risk determination system 400, according to one embodiment. The blocks that represent features in FIG. 4 can be arranged differently than as illustrated, and can implement additional or fewer features than what are described herein. Further, the features represented by the blocks in FIG. 4 can be combined in various ways. The system 400 can be implemented using hardware, hardware and software, hardware and firmware, or a combination thereof.

The change risk determination system 400, according to one embodiment, includes hardware, an input-value-receiving-logic 204, an analyzing-values-logic 302, a valid-trained-neuro-fuzzy-expert-system-logic 206, and a level-of-change-risk-determination-logic 208. Examples of the hardware could be a tangible computer readable storage medium for storing instructions or a hardware processor for executing instructions, such as a central processing unit, or a combination thereof. Examples of instructions are computer-executable instructions for implementing the input-value-receiving-logic 204, the valid-trained-neuro-fuzzy-expert-system-logic 206, and the level-of-change-risk-determination-logic 208. The logic may be implemented as computer-executable instructions, firmware or hardware, such as circuitry.

The system 400 can be triggered, for example, by a computer-implemented process implementing a change management method or by a human operator providing any kind of input data related to a change.

Corresponding values specifying the change risk can be received by the input-value-receiving-logic 204. These values can, for example, be related to a number of input parameters which determine the change risk or can constitute a number of input words which in combination can define a description of the related change risk. The input-value-receiving-logic 204 can receive values from a human, such as an operator, user, or expert, or combination thereof. Also, a first group of inputs can be received from a human while another group of inputs can be retrieved from a data base or data store or another automated system or application, such as a monitoring application.

The values of the different fuzzy inputs can be analyzed by analyzing-values-logic 302. The analysis can fully interact with a neuro-fuzzy expert system logic 206 to calculate a fuzzy output. For example, the values of the different inputs can be mapped onto a fuzzy set and a set of fuzzy rules defined by the valid-trained-neuro-fuzzy-expert-system-logic can be applied to compute the fuzzy output, for example by combining a set of fuzzy outputs for each fuzzy rule. The valid-trained-neuro-fuzzy-expert-system-logic can furthermore define an inference engine which specifies a hierarchy for the application of the fuzzy rules.

The fuzzy output can further include a linguistic value O1.1 (FIG. 1). The linguistic value O1.1 (FIG. 1) can be computed from resulting fuzzy set and corresponding membership degrees as determined by the valid-trained-neuro-fuzzy-expert-system-logic 206. For example, fuzzy output sets of fuzzy rules can be combined into a single set of fuzzy outputs, representing the linguistic value O1.1 (FIG. 1). The outputs of each rule can be combined in different ways, such as using one of a maximum method, a bounded sum method, and a normalized sum method and other suitable methods. Also, the membership degrees of all members of the resulting fuzzy set can be analyzed in order to derive a further approximation of the linguistic value O1.1 (FIG. 1).

In addition, a crisp value O1.2 (FIG. 1) can be provided. The crisp value O1.2 can refer to a numerical or real value which can be derived by a defuzzification of the resulting set of fuzzy outputs and its membership degrees. In order to determine the crisp value O1.2, the geometry and shape of the membership functions of the resulting set of fuzzy outputs can be analyzed and superimposed to derive a numerical value, for example, from a centroid resulting from the superimposed functions.

Based on both output values, the linguistic value O1.1 and the crisp value O1.2, a risk of the change can be determined by a level-of-change-risk-determination-logic 208. For example, the changes can be classified by their level of risk according to the linguistic value O1.1 and, subsequently, a level of risk of the change (also referred to as “grading”) can be determined using the crisp value O1.2. Hence, the linguistic value O1.1 can be used to determine a class or category for each risk of change and the crisp value O1.2 can be used to index the risk of change in that class or category. Yet, the crisp value O1.2 can also be used to further affect the determined class or category, such that a risk of change can be reclassified into a neighboring class or category if the crisp value O1.2 exceeds or falls below a certain threshold.

After the determination of the level of risk of the change (also referred to as “change risk”) by the level-of-change-risk-determination-logic 208, the processing, according to one embodiment, is complete. Upon completion, processing and the determined level of risk of the change can be passed to another management process, which can subsequently provide the outputs of the analysis to a human operator or an automated processing entity or both.

Therefore, according to various embodiment, a change risk determination system 200, 400 (FIGS. 2 and 4) is provided that includes trained-valid-neuro-fuzzy-expert-system-logic 206 that is used as a part of analyzing changes to the IT infrastructure and the risk that results from those changes. According to one embodiment, the change risk determination system 200, 400 combines an intelligent technique like fuzzy logic, neural networks, ITIL framework recommendations and practice techniques. According to one embodiment, the change risk determination system 200, 400 can execute the process of change risk analysis and assessment in the IT service management area using the trained-valid-neuro-fuzzy-expert-system-logic. The change risk determination system 200, 400 can deal with the ambiguity of representations of human expert knowledge by using fuzzy logic. Ambiguity can be defined as a condition where there is limited knowledge or it is not possible to precisely define the current state or future result.

According to one embodiment, the change risk determination system 200, 400 can deliver a new approach for better and more intelligent use of the human expert knowledge for change risk analysis and uses fuzzy logic to quantify more realistically the classical change risk analysis and to arrive at conclusion that represents the risk of making a change. Additionally the change risk determination system 200, 400 can implement the neural networks learning capabilities. A valid-trained-neuro-fuzzy-expert-system-logic 206 combines a neural network with learning capabilities combined with fuzzy logic, which can deliver the best of both

The change risk determination system 200, 400 can be implemented on a single server, distributed across a plurality of serves, or as cloud based solution. The cloud based solution can optimize the management of resources, costs, storage and performance based on the corporate or regulatory policies or a combination thereof.

FIG. 5 depicts a hierarchical neural network 500, according to one embodiment.

FIG. 5 depicts a hierarchical neural network 500 where the hierarchy has levels 1-10.

FIG. 5 depicts inputs I1-I11, input terms IT1.1, IT1.n, IT2.1, IT2.n, IT3.1, IT3.n, IT11.1, IT11.n, rules blocks levels 1-10 where there are rules r1-rn for each of the rules blocks levels 1-10, output terms OT1.1, OT1.m, OT2.1, OT2.m, OT10.1, OT10.m, and outputs O1, O2 and O10.

Inputs, input terms, rules, output terms and outputs are associated with each level. For example, input I1, input terms IT1.1, IT1.n, rules r1.1, r1.2, r1.n1, output terms OT1.1, OT1.m, OT2.1, OT2.n and output O1 are associated with level 1. Input I2, input term IT2.1, IT2.n, rules r2.1, r2.2, r2.n2, output term OT2.1, OT2.m and output O2 are associated with level 2. Input I11, input term I11.1, I11.n, rules r10.1, r10.2, r10.n10, output term OT10.1, OT10.m and output O10 are associated with level 10.

Each of the I_TERMS IT 1.1, 1.n, 2.1 and 2.n associated with the first two inputs I1 and I2 are linked with each of the rules r1.1, r1.2, r1.n1 for the first level. Each of the i_terms IT3.1, 3.n associated with the input I3 of the second level and the output O1 of the first level are linked with each of the rules r2.1, r2.2 to r2.n2 for the second level. Each of the i_terms IT10.1, IT10.n associated with the input I10 of the tenth level and the output O9 (not shown) of the ninth level are linked with each of the rules r10.1, r10.2 to r10.n10 for the tenth level.

As depicted in FIG. 5, the data flow is depicted in the context of 11 inputs. For example, the valid-trained-neuro-fuzzy-expert-system can include a loop where, for example, the first iteration processes a first set of inputs I1, I2 to determine a first set of rules r1.1, r1.2, r1.n1, which result in the output terms OT1.1, OT1.m, and a first set of outputs O1. The second iteration can receive a second set of inputs I2 and the first set of outputs O1 and process them using a second set of rules r2.1, r2.2, r2.n2, which result in the output terms OT2.1, OT2.m and a second set of outputs O2. For the sake of illustration, iterations between the second iteration and the last iteration are not depicted. In the last iteration, the ninth set of outputs and the tenth set of inputs I11 can be received and processed using the tenth set of rules r10.1, r10.2, r10.n10, resulting in the output terms 10.1, 10.m and output 10. Each of the outputs 1, 2 . . . 10 can be specified in terms of a linguistic value, a crisp value, or a combination thereof.

Still referring to FIG. 5, in a first hierarchical level, the fuzzy inputs I1, I2 can be combined in pairs and subjected with their fuzzy input terms 1.b to one of the fuzzy rules 1.c. Furthermore, fuzzy outputs o1.1 and o1.2 associated with a previous level can be combined in pairs with the second fuzzy input 1.a of the next level and subjected to another set of fuzzy rules' 1.c in the next hierarchical level to generate the fuzzy outputs 1.e in a next level of the hierarchy. The result of each application of one of the fuzzy rules 1.c can be another fuzzy set with respective degrees of membership. The membership functions of each fuzzy set can be defined as triangular, trapezoidal or sinusoidal functions or any other function suitable to describe a degree of membership.

FIG. 5, according to one embodiment, depicts a high level structure view of the hierarchical neuro-fuzzy expert system logic of the fuzzy layer of a system 200, 400, according to one embodiment. FIG. 5 depicts processing of all eleven input variables organized as hierarchical structure, according to one embodiment. Because the business impact and possible finance lost of each IT infrastructure change is crucial for each organization, according to one embodiment, the last two input variables (which can put more weight on the result calculation) are the Impacted Business Services and Processes and the Estimated Financial Impact. By placing the Impacted Business Services and Processes and the Estimated Financial Impact as the last two input variables, they can be provided more weight in the final output 10.

FIG. 6 depicts a flowchart 600 for generating a valid trained neural network, according to one embodiment.

At 602, the method starts.

An “empty” fuzzy neural network is developed and defined in advance before the training process is started. The empty fuzzy neural network can include defined fuzzy input variables, membership functions of fuzzy input term values, fuzzy rules, fuzzy rule blocks, fuzzy output variables, membership functions of the fuzzy output term values. The suggested fuzzy input variables, input terms, output terms and fuzzy rules are described herein.

At 603, training data is received. For example, training data may be provided manually by a human expert trainer, may be received automatically from another system, may be based on historical data, or a combination thereof. The training data, according to one embodiment, is available training sets of input and output values that are representative. The training data can be stored in a training neural network database. The training data can be obtained from daily operations of a system 200 or 400 or other similar system and modified by a human expert trainer to eliminate irrelevant and insignificant values. For successful training, the training data is well defined and specific policy can be available to determine the sequence of the sample data applied to the training at 604.

At 604, training is performed based on the training data. For example, training based on the training data can result in generating fuzzy input terms, fuzzy rules and fuzzy output terms. The fuzzy input terms, the fuzzy rules and the fuzzy output terms can be used to generate a trained neural network which can be included in trained-neuro-fuzzy-expert-system-logic. Based on the training data, the fuzzy membership functions which are defined in the fuzzy input terms and the fuzzy rules can be changed, as described herein. The fuzzy output terms can be changed in meaning.

The training performed by operation 604, according to one embodiment, uses a back propagation technique which compares the computed output of the neural-fuzzy system logic with the output from the training neural network data stored in the training neural network database and computes the deviation. Based on it the neural-fuzzy network, weights of the fuzzy rules 1.c (FIG. 1) are modified or the fuzzy input terms 1.b (FIG. 1), which are parameters of the membership functions, are adjusted or the fuzzy output terms 1.d (FIG. 1), which are parameters of the membership functions, are adjusted. Based on the fuzzy rules 1.c (FIG. 1), weights w1.1-w1.9 are changed by starting from the output neurons and going backward through the network to input neurons. The loop 614 depicted in FIG. 6 indicates that this training process executes these operations 603-608 until the average error is reduced to a predefined threshold. Redundant or unnecessary rules can be deleted if they are found during the training.

At 606, the trained neural work is validated and optimized providing a valid trained and optimized neural network. The validation and optimization can be performed automatically or manually or a combination thereof. A human expert can manually check, optimize, and validate the trained neuro-fuzzy expert system.

After the completion of the training of the fuzzy neural network, the trained fuzzy neural network can be validated at operation 606 by testing it with sample data and analyzing the outputs.

According to one embodiment, parameters of the trained neural network can be changed and the overall trained neural network can be optimized as a part of the operation 606.

At 608, a determination is made as to whether the trained neural network is valid.

If the results of the texting and analysis are satisfactory, processing continues to 610. For example, if the achieved results are satisfactory and, therefore, the trained neural network is a valid neural network, then the trained neural network is valid and ready to be used in operational mode. During the operational mode, the processed input and calculated output values can be used as training neural network data in the future.

If the results of the testing and analysis are not satisfactory, the loop 614 can be executed again until acceptable results are achieved. For example, if the trained neural network is not valid, the process can return to 602 and another iteration of the loop 614 can be performed to improve the neural network that was generated in the previous iteration.

At 610, the valid trained neural network is stored and processing continues to 612.

At 612, the method ends.

After completion of the method depicted by flowchart 600, according to one embodiment, the valid trained neural network, which may also be optimized, is used as a valid-trained-fuzzy-expert-system-logic 206. Further, the valid-trained-neuro-fuzzy expert system 206 can be used to analyze input values and determine a level of risk of making a change based on the analyzing of the input values.

The method depicted in FIG. 6 can be repeated, for example, when the organizational IT infrastructure, data, conditions, and policies are changed. Later this method can be performed from time to time, for example, to ensure compliance and optimal analysis of the IT infrastructure changes.

According to one embodiment, the training-neural-network-logic performs operation 604. According to one embodiment, the validating-and-optimizing-trained-neural-network-logic performs operation 606.

The operations depicted in FIGS. 3 and 6 can be implemented as computer executable instructions, hardware or firmware. According to one embodiment, a system 200, 400 can perform one or more of the operations depicted in FIGS. 3 and 6. According to one embodiment, one or more of the operations depicted in FIGS. 3 and 6 may be performed by another system. The other system can include hardware, such as a central processing unit, for executing computer executable instructions.

Creating, accessing, or using a neuro-fuzzy-expert-system-logic 206 are examples of modifying data to transform the state of system, such as systems 200, or 400.

Although specific operations are disclosed in flowcharts 300 and 600, such operations are exemplary. That is, embodiments of the present invention are well suited to performing various other operations or variations of the operations recited in flowcharts 300 and 600. It is appreciated that the operations in flowcharts 300 and 600 may be performed in an order different than presented, and that not all of the operations in flowcharts 300 and 600 may be performed.

The above illustration is only provided by way of example and not by way of limitation. There are other ways of performing the method described by flowcharts 300 and 600.

Unless otherwise specified, any one or more of the embodiments described herein can be implemented using non-transitory computer readable storage medium and computer-executable instructions which reside, for example, in computer-readable storage medium of a computer system or like device. The non-transitory computer readable storage medium can be any kind of memory that instructions can be stored on. Examples of the non-transitory computer readable storage medium include but are not limited to a disk, a compact disk (CD), a digital versatile device (DVD), read only memory (ROM), flash, and so on. As described above, certain processes and operations of various embodiments of the present invention are realized, in one embodiment, as a series of computer-executable instructions (e.g., software program) that reside within non-transitory computer readable storage memory of a computer system and are executed by the computer processor of the computer system. When executed, the instructions cause a computer system to implement the functionality of various embodiments of the present invention. For example, the instructions can be executed by a central processing unit associated with the computer system. According to one embodiment, the non-transitory computer readable storage medium is tangible.

Unless otherwise specified, one or more of the various embodiments described herein can be implemented as hardware, such as circuitry, firmware, or computer-executable instructions that are stored on non-transitory computer readable storage medium. The computer-executable instructions of the various embodiments described herein can be executed by a hardware processor, such as a central processing unit, to cause a computer system to implement the functionality of various embodiments.

The following can be achieved using various embodiments described herein:
Complex risk analysis based on large number of input parameters
Automatically executed expert analysis and change risk definition
Better objectivity of the defined change risks
Detailed changes classification based on the defuzzified (numeric) output value of the calculated risk
Use of expert knowledge define in internal system rules and fuzzy variable definition
Increased user satisfaction
Decreased number of incidents and problems resulting from poor change risk analysis and incorrect risk definition
Decreased business services and operations interruptions resulting from more objective and intelligent change risk assessment and analysis
Decreased dependency and the costs of maintaining human experts for risk analysis.
Dealing with the ambiguity, incomplete and incorrect information during the change analysis and its risk determination.

The future in IT service management is in the automated intelligent processes and technologies and that's why various embodiments described herein can be technically relevant in the next 5-10 years. The fuzzy logic based systems provide good calculation capabilities for intelligent risk analysis thus providing:
Possibility for parallel calculations
Possibility for gathering proves for and against the searched proposition
Possibility for work with vague information on higher level of precision
Less experience specialist are necessary for building complex models
Less time for building the design and prototype of the model
Less time for discovering and removing errors
Less time necessary for checking and bettering the model

Example embodiments of the subject matter are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

Various embodiments have been described in various combinations and illustrations. However, any two or more embodiments or features may be combined. Further, any embodiment or feature may be used separately from any other embodiment or feature. Phrases, such as “an embodiment,” “one embodiment,” among others, used herein, are not necessarily referring to the same embodiment. Features, structures, or characteristics of any embodiment may be combined in any suitable manner with one or more other features, structures, or characteristics.

Although various embodiments were described in the context of both a linguistic output O1.1 and a crisp output O1.2, various embodiments are well suited to either the linguistic output O1.1 or the crisp output O1.2 or both the linguistic output O1.1 and the crisp output O1.2.

Although various embodiments were discussed in the context of a certain number of layers, inputs, input terms, rules, output terms, outputs and so on, various embodiments are well suited for different numbers of layers, inputs, input terms, rules, output terms and outputs, among other things.

What is claimed is:

1. A method of determining a level of risk for making a change, the method comprising
generating valid-trained-neuro-fuzzy-expert-system-logic based on training data;
receiving a plurality of input values;
analyzing the input values using the valid-trained-neuro-fuzzy-expert-system-logic; and
determining a level of risk of making the change based on the analyzing of the input values, wherein the method is executed by one or more hardware processors.

2. The method as recited by claim 1, wherein the determining of the level of risk of making the change further comprises:
determining a linguistic value and a corresponding crisp value that indicate the level of risk of making the change.

3. The method as recited by claim 1, wherein the method further comprises:
receiving training data; and
generating a trained neural network based on the training data, wherein the valid-trained-neuro-fuzzy-expert-system-logic is a combination of includes the trained neural network and an expert system.

4. The method as recited by claim 3, wherein the generating of the trained neural network further comprises:
generating a hierarchical trained neural network that has a plurality of layers.

5. The method as recited by claim 4, wherein the method further comprises:
determining a fuzzy output based at least in part on rules that are specified in terms of more than one fuzzy input using logical operators.

6. The method as recited by claim 1, wherein the receiving of the plurality of input values comprises:
receiving fuzzy input parameters including Impacted business services and processes, affected configuration items, necessary people resources for change implementation, related changes, organizational visibility, back out efforts, number of resources with necessary experience, expected time for change completion, change implementation time, estimated financial impact, people affected wherein each of the fuzzy input parameters have a fuzzy value.

7. A system for determining a level of risk for making a change, the system comprising:
hardware;
input-value-receiving-logic configured for receiving a plurality of input values;
valid-trained-neuro-fuzzy-expert-system-logic configured for analyzing the input values; and
level-of-change-risk-determination-logic configured for determining a level of risk of making the change based on the analyzing of the input values.

8. The system of claim 7, wherein the system further comprises:
training-neural-network-logic configured for receiving training data and generating a trained neural network by training a neural network based on the training data, wherein the valid-trained-neuro-fuzzy-expert-system-logic includes the trained neural network.

9. The system of claim 8, wherein the training-neural-network-logic modifies fuzzy input terms, fuzzy rules, and fuzzy output terms based on the training data.

10. The system of claim 8, wherein the system further comprises:
validating-and-optimizing-trained-neural-network-logic configured for generating a valid neural network by validating and optimizing the trained neural network.

11. The system of claim 8, wherein the trained neural network is a hierarchical trained neural network with a plurality of layers.

12. A non-transitory computer readable storage medium having computer-executable instructions stored thereon for causing a computer system to perform a method of determining a level of risk for making a change, the method comprising:
generating valid-trained-neuro-fuzzy-expert-system-logic;
receiving a plurality of input values;
analyzing the input values using the valid-trained-neuro-fuzzy-expert-system-logic; and
determining a level of risk of making the change based on the analyzing of the input values.

13. The non-transitory computer readable storage medium as recited by claim 12, wherein the method further comprises:
receiving training data; and
generating a trained neural network based on the training data, wherein the valid-trained-neuro-fuzzy-expert-system-logic is a combination of includes the trained neural network and an expert system.

14. The non-transitory computer readable storage medium as recited by claim 13, wherein the generating of the trained neural network further comprises:
generating a hierarchical trained neural network that has a plurality of layers, wherein the layers include fuzzy input value nodes, fuzzy input value term nodes, fuzzy rule nodes, fuzzy output value term nodes, fuzzy output value nodes.

15. The non-transitory computer readable storage medium as recited by claim 14, wherein the method further comprises:
determining fuzzy output based at least in part on rules that are specified in terms of more than one fuzzy input using logical operators, wherein the fuzzy inputs include impacted business services and processes, affected configuration items, necessary people resources for change implementation, related changes, organizational visibility, back out efforts, number of resources with necessary experience, expected time for change completion, change implementation time, estimated financial impact, people affected wherein each of the fuzzy inputs have a fuzzy value.
